(19) United States
(12) Patent Application Publication
(10) Pub. No.: US 2002/0000325 A1
(43) Pub. Date: Jan. 3, 2002

(54) Hand-held hammer drill

(76) Inventors: Gunnar Wijk, Enskede (SE); Diethard Fohr, Winnenden (DE); Alexander Krug, Leutenbach (DE)

Correspondence Address: Gudrun E. Huckett, Ph.D., P.O. Box 3187, Albuquerque, NM, 87190-3187, US

(21) Appl. No.: 09/858,158

(22) Filed: May 14, 2001

(30) Foreign Application Priority Data
Jun. 2, 2000 (EP) 00111730.8

(51) Int. Cl. B25D 9/00

(52) U.S. Cl. 173/206

(57) ABSTRACT

A hand-held hammer drill has a housing and an electric drive motor arranged in the housing. A tool spindle is arranged in the housing and configured to receive a tool. The tool spindle can be driven in rotation by the electric drive motor. The tool spindle has a longitudinal axis and is oscillatingly moveable in a direction of the longitudinal axis. A hammer mechanism is provided to move the tool spindle oscillatingly in the direction of the longitudinal axis. A hydraulic drive is arranged in the housing and configured to drive the hammer mechanism. The hydraulic drive has a hydraulic pump generating a hydraulic pressure for driving the hammer mechanism.

### BACKGROUND OF THE INVENTION

1. Field of the Invention

The invention relates to a hand-held hammer drill for drilling holes, cutting slots for receiving cables, or the like in concrete, stone or similar materials.

2. Description of the Related Art

For machining concrete, stone or similar materials, impact drilling machines and hammer drills with a rotating tool spindle are used in which, for example, a drill bit, in particular, with a hard metal chisel tip, is used. By means of a hammer mechanism the tool spindle is caused to perform an oscillating longitudinal movement so that the chisel tip of the inserted drill bit chisels pieces from the brittle material to be machined. As a result of the rotational movement of the tool spindle and of the drill bit in connection with a groove extending spirally about the drill bit, the material pieces that have been chiseled out are transported away so that a hole results. In so-called impact drilling machines, the oscillating impact action of the tool spindle is caused, for example, by an axial cam disc. The transmittable impact energy and the corresponding drilling efficiency depend to a great extent on the pressing force or contact pressure of the impact drilling machine against the material to be drilled which force must be applied by the operator. A high drilling efficiency requires thus a high force application by the operator which can result in an undesirable, quick fatigue.

Hammer drills with a pneumatically driven hammer mechanism are also known in which the oscillating hammer action of the tool spindle is caused by application of an oscillating air pressure. Such hammer drills require only a minimal pressing force but because of the pneumatic drive in connection with the space and weight limitations of a hand-held device, only a limited impact energy results. At times, this limitation can result in an unsatisfactory drilling efficiency, especially for very hard materials to be machined or a large number of holes to be drilled.

### SUMMARY OF THE INVENTION

It is an object of the present invention to develop a hand-held hammer drill such that its handling is facilitated.

In accordance with the present invention, this is achieved in that the hand-held hammer drill comprises a tool spindle, which is rotatable about a rotational axis and is oscillatingly movable in the direction of the rotational axis in the longitudinal direction of the tool spindle and is configured for receiving a drill, a chisel or the like. The hammer drill comprises a housing with an electrical drive motor arranged therein for realizing the rotational movement of the tool spindle and with a hammer mechanism for generating the oscillating longitudinal movement of the tool spindle, wherein the hammer mechanism is hydraulically driven and the hydraulic pressure is generated by a hydraulic pump arranged in the housing.

Accordingly, the present invention suggests to drive the hammer mechanism of the hammer drill hydraulically and to provide the hydraulic pressure within the device. With this configuration, a hammer drill of a comfortable size with significantly increased specific impact or hammer energy is provided, while a large size and unreliable drive hydraulic supply lines are eliminated. In this connection, the hammer mechanism together with the hydraulic drive, relative to the obtainable impact or hammer energy, can be lightweight and compact so that an operator can easily perform even difficult tasks such as, for example, overhead drilling or the like, with reduced physical stress. It is preferred in this context to embody the tool spindle and the hammer mechanism separate from one another wherein both have a contact surface. The contact surfaces face one another and can be brought into contact with one another. Accordingly, the operator can press the hammer drill with the clamped drill bit with reduced pressing force against the material to be drilled. In the hammer mechanism, which operates independently from the tool spindle, the impact energy is built up and is then transmitted via the contact surfaces, according to the principle of a hammer, onto the tool spindle or the drill bit and thus onto the workpiece. This provides at the same time a high drilling efficiency with reduced force expenditure of the operator. The hammer mechanism is preferably embodied as a system comprised of a cylinder and a push rod with a piston guided in the cylinder, and, in particular, the hammer mechanism is arranged aligned with the axis of the tool spindle. Accordingly, while avoiding force deflections and energy losses, a direct transmission of the hammer or impact energy from the push rod onto the tool spindle is ensured. In a preferred embodiment of the invention, the piston can be loaded with hydraulic pressure on both ends in the hammer action direction as well as in the opposite return direction. Accordingly, the push rod performs a return movement even without applying pressing force, and this also results in a relief for the operator.

In an advantageous embodiment, the piston has an effective piston surface area in the return direction which is smaller than the effective piston surface area in the hammer action direction. Preferably, the active piston surface area active in the return movement direction is approximately 10% of the effective piston surface area in the hammer action direction. This realizes, on the one hand, a high push rod speed in the hammer action direction and thus a high impact energy. On the other hand, the return of the piston together with the push rod is realized with a reduced force so that a reduced vibration load results. Moreover, a simple control of the hammer mechanism can be achieved in that the piston surface area effective in the return direction is continuously loaded with a high hydraulic pressure. A suitable control device then must only control the pressure acting in the hammer action direction in that the corresponding piston surface area is alternatingly loaded with high and low hydraulic pressures. When a high pressure is applied, the force acting in the hammer action direction is greater, because of the larger effective piston surface area, than the hydraulic force acting in the return direction. When switching from high hydraulic pressure to low hydraulic pressure, the total force acting in the return direction is greater in the case of a suitable piston surface area ratio, so that the piston together with the push rod is returned. For controlling the hammer mechanism, it is thus only required to provide a simple control valve which acts on the hammer action side of the piston so that the constructive and manufacturing technological expenditure can be maintained at a low level.

Expediently, a hydraulic circuit is provided in the hammer drive which comprises a low-pressure part, a high pressure part, and a hydraulic pump arranged therebetween, which generates, especially continuously, high hydraulic pressure in the high pressure part. Accordingly, a suitable pressure potential is permanently available which can be supplied, as needed, with a suitable control device and with minimal losses to the hammer mechanism. The hydraulic pump is advantageously a gear pump so that a simple configuration with a high efficiency is provided. In an expedient further development, the hydraulic pump is driven by the drive motor of the hammer drive. Accordingly, an additional drive can be eliminated, and this is space-saving and cost-saving. In particular, in connection with a hammer mechanism and rotary drive that can be switched on and off as desired, the required power is thus available immediately for both devices, separately or in combination. Advantageously, in the low-pressure part a low-pressure storage chamber for storing hydraulic oil is provided which is divided, in particular, by means of a diaphragm, into a hydraulic chamber filled with hydraulic oil and into a compensation chamber. Accordingly, a hydraulic oil reservoir is available with which, for example, oil losses can be compensated and into which the leakage oil can be returned. By means of the diaphragm, the hydraulic circuit is sealed so that a position-independent working is possible with the hammer drill. By loading the compensation chamber with atmospheric pressure, a substantially constant supply pressure can be achieved in the low-pressure part via the elastic diaphragm. In an analogous manner, in the high pressure part a high pressure storage chamber is provided which is also preferably divided by a diaphragm into a hydraulic chamber and into a compensation chamber. The compensation chamber of the high pressure storage chamber has a pressure of approximately 16 to 18 bar and thus of approximately half the operating pressure of the high pressure part of approximately 34 bar. The filling medium is expediently nitrogen. By means of the high pressure storage chamber, pressure peaks in the high pressure part can be smoothed which can be caused by the hydraulic pump or by the feedback of the hammer mechanism. This ensures an approximately uniform and defined working pressure.

As a control means for the hammer mechanism a control valve has been found to be expedient which is hydraulically actuated. Accordingly, while eliminating a complex mechanical connection of the control valve to the hammer mechanism and while taking advantage of the already present hydraulic circuit, an effective control of the hammer mechanism with minimal constructive and manufacturing technological expenditure can be obtained. In an expedient configuration of the control valve, it is connected to a control line and is configured such that, as a function of the pressure in the control line, it can be switched back and forth between a hammer action position and a return position. The presence of a single control line further simplifies the configuration.

For controlling the control valve, in particular, by means of a single control line, the piston of the hammer mechanism has also correlated therewith a control function. For this purpose, it is provided at its periphery with an annular recess which forms an annular control chamber together with the cylinder. The control chamber is connected with the low-pressure part of the hydraulic circuit so that a low hydraulic pressure is continuously present in the control chamber. The control chamber divides the piston into a hammer action piston and a control piston. In the wall of the cylinder a high pressure opening and a low-pressure opening are provided which are staggered in the axial direction relative to one another. They can be alternatingly covered by the control piston. The high pressure opening and the low-pressure opening are connected with the control line. As a result of the oscillating movement of the push rod together with the control piston and the thus resulting alternating coverage of the high pressure opening and low-pressure opening, an oscillating loading of the control line with high or low hydraulic pressure is realized so that the control valve can be switched back and forth in a simple way between both positions. In this connection, the control piston and the high pressure opening and low-pressure opening are aligned relative to one another such that the movement of the push rod in its return direction can be hydraulically braked or decelerated so that the vibration level of the hammer mechanism and thus of the entire hammer drill is reduced. For a further reduction of the vibration level an anti-vibration device is provided which is active in the hammer action direction and which is embodied, in particular, as a vibration damper with a counter oscillator-suspended from a spring element. With a corresponding adjustment of the spring strength of the spring element and the mass of the counter oscillator, an effective vibration damping action can be provided with simple means.

In an advantageous embodiment of the invention, the rotary drive of the tool spindle and the hammer mechanism can be switched on and off independently of one another. With this measure, it is possible, for example, to operate the hammer drill with rotating tool spindle without hammer action, which can be used, for example, for drilling sensitive tile or the like. Also, with the rotary drive of the tool spindle switched off, the hammer mechanism can be operated alone so that the hammer drive can be used, for example, as an electric chisel for cutting slots for placing cable, tubing or the like.

### BRIEF DESCRIPTION OF THE DRAWING

In the drawing:

FIG. 1 is a schematic overview representation of a hydraulic hammer drill with all the essential components;

FIG. 2 is a schematic illustration of the hydraulic circuit and the hammer mechanism of the hammer drill according to FIG. 1, showing the hammer mechanism in contact with the tool spindle, respectively, the tool;

FIG. 3 shows a detail of the illustration according to FIG. 2 with the push rod in the return movement;

FIG. 4 is an illustration according to FIG. 3 with the control valve being switched for braking the push rod;

FIG. 5 is a representation of the arrangement according to FIG. 3 at the beginning of the hammer action movement of the push rod;

FIG. 6 is an illustration of the arrangement according to FIG. 3 with the push rod shortly before impacting on the tool spindle and with the control valve shown shortly before switching into the position for generating the return movement.

### DESCRIPTION OF THE PREFERRED EMBODIMENTS

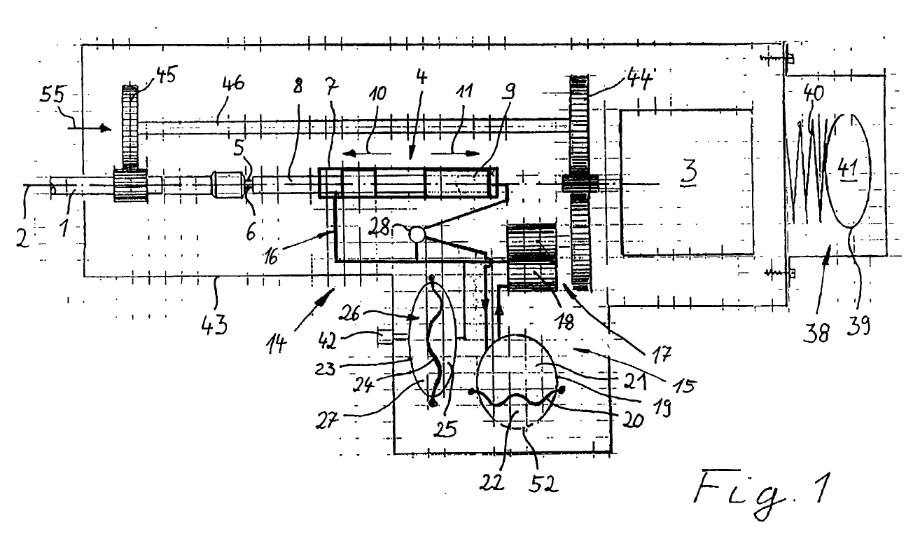

FIG. 1 shows in a schematic overview illustration the hydraulic hammer drill according to the invention. In a housing 43 (only schematically illustrated) an electrical drive motor 3 is arranged which is configured to drive a tool spindle 1, rotatable about a rotational axis 2, by means of a first gear stage 44, a shaft 46, and a second gear stage 45. The rotary drive of the tool spindle 1 is, for example, switched off by a longitudinal movement of the shaft 46 in the direction of arrow 55 and can be switched on again by a movement in the opposite direction.

The tool spindle 1 can be longitudinally moved in the direction of the rotational axis 2, wherein the longitudinal movement is oscillatingly and is actuated by means of a hydraulically driven hammer mechanism 4. The hammer mechanism 4 can be switched on and off independent of the rotary drive of the tool spindle 1. The tool spindle 1 and the hammer mechanism 4 can be connected with one another so that the oscillating movement of the hammer mechanism 4 can be directly transmitted onto the tool spindle 1. In the illustrated embodiment, the two components are embodied separate from one another. Each has a contact surface 5, 6 which are facing one another and with which they can be brought into contact with one another. The hammer mechanism 4 comprises a cylinder 7 in which a push rod 8 with a piston 9 is guided. The piston 9 is loadable by means of a control valve 28 on both ends with hydraulic pressure wherein the hydraulic pressure, depending on the position of the control valve 28, acts in the hammer action direction 10, indicated by the arrow 10, or in the return direction 11, indicated by the arrow 11. An embodiment of the hammer mechanism 4 can be expedient in which the hydraulic pressure acts only in the hammer action direction 10 and a return movement of the push rod 8 is realized by the contact pressure of a tool clamped in the tool spindle 1.

For driving the hammer mechanism 4, a hydraulic circuit 14 with a low-pressure part 15 and a high-pressure part 16 is provided between which a hydraulic pump 17 in the form of a gear pump 18 is arranged. The hydraulic pump 17 arranged in the housing 43 can be driven separately by its own motor; but in the illustrated embodiment it is advantageously driven by the electric drive motor 3 by means of the first gear stage 44. For storing and returning hydraulic oil, a low-pressure storage chamber 19 is provided in the low-pressure part 15 which is divided by a diaphragm 20 into by a hydraulic chamber 21 and a compensation chamber 22. The compensation chamber 22 is filled with air and has pressure compensation openings 52 as a result of which it can be loaded with atmospheric pressure. The atmospheric pressure is transmitted via the elastic diaphragm 20 onto the hydraulic chamber 21 as a result of which atmospheric pressure is present in the low-pressure part 15.

Analogously, a high-pressure storage chamber 23 is provided in the high-pressure part 16 which is divided by a diaphragm 24 into a hydraulic chamber 25 and a compensation chamber 27. The compensation chamber 27 can be filled via a valve 42 with gas, wherein the gas may be compressed air. In the illustrated embodiment the compensation chamber 27 is filled with nitrogen at a pressure of approximately 16 to 18 bar, wherein the pressure in the compensation chamber 27 determines the static hydraulic pressure within the high-pressure part 16 via the elastic diaphragm 24 when the hydraulic pump 17 is not active. The hydraulic pump 17 provides during operation an operating pressure in the high-pressure part 16 of approximately 34 bar.

For reducing the vibration level resulting from the oscillating movement of the push rod 8 and of the tool spindle 1, an anti-vibration device 38 which is active in the hammer action direction 10 is provided at the side of the drive motor 3 facing away from the tool spindle 1. The anti-vibration device 38 can be in the form of an elastic suspension of the hammer mechanism 4, a suitable arrangement of impact damping means or the like; in the illustrated embodiment it is provided in the form of an adjusted vibration damper 39 with a spring element 40, connected to the housing 43, and a counter oscillator 41 suspended on the spring element 40. The tool spindle 1, the hammer mechanism 4, and the anti-vibration device 38 are approximately aligned with one another on a common axis.

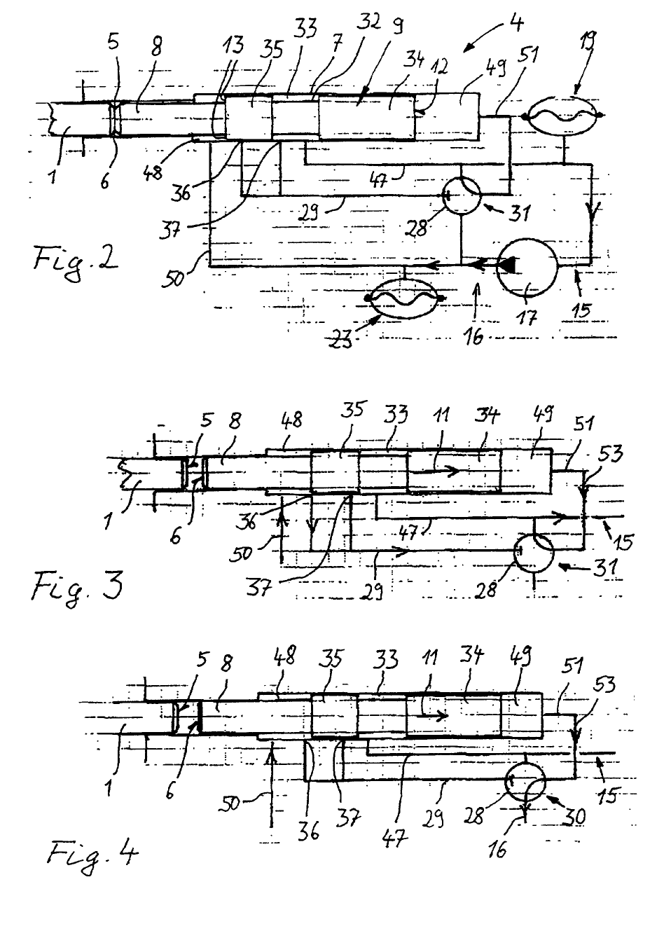

FIG. 2 shows in a schematic detail the hammer mechanism 4 and the hydraulic circuit 14 of the hammer drill according to FIG. 1. The push rod 8 and the tool spindle 1 are contacting one another via their two contact surfaces 5, 6 so that the push rod 8 can transmit its impact energy onto the tool spindle 1. The piston 9 has peripherally an annular recess 32 which together with the piston 7 provides an annular control chamber 33. The control chamber 33 is permanently connected via a low-pressure line 47 with the low-pressure part 15 of the hydraulic circuit 14. As a result of the annular recess 32, the piston 9 is divided into a hammer action piston 34 and a control piston 35. Together with the cylinder 7, the hammer action piston 34 provides at its end face a hammer action chamber 49 which is connected by means of a hammer action line 51 with the control valve 28. Moreover, the cylinder 7, together with the control piston 35 and the push rod 8, forms an annular return chamber 48 at the side facing the tool spindle 1. The annular return chamber 48 is continuously connected by means of a high-pressure line 50 with the high-pressure part 16 and the high-pressure storage chamber 23. The hydraulic pressure in the high-pressure part 16 generates via the effective piston surface area 13 on the control piston 35 a force component onto the push rod 8 in the return direction 11 (FIG. 1). The effective piston surface area 13 is approximately 10% of the effective piston surface area 12 acting in the opposite direction on the hammer action piston 34 by which the push rod 8 is moved in the hammer action direction 10 (FIG. 1) when a corresponding pressure in the hammer action chamber 49 is present. The push rod 8 can be formed as a continuous or unitary part extending through the cylinder 7 as a result of which, via the two effective piston surface areas 12, 13 (see FIG. 2-6) acting in both directions, the movement speed of the push rod 8 is approximately identical in both directions.

A high-pressure opening 36 and a low-pressure opening 37 are arranged at the periphery of the cylinder 7 in the area of the control piston 35 and are connected with the control line 29. They are covered alternatingly by the control piston 35. According to FIG. 2, the high-pressure opening 36 is covered by the control piston 35, while the low-pressure opening 37 is open. Accordingly, the control line 29 is connected with the control chamber 33 so that the hydraulic pressure of the low-pressure part 15 of the hydraulic circuit 14 is present therein. The control valve 28 is connected with the control line 29 and configured such that, as a function of the pressure present in the control line 29, it can be switched back and forth between two switching positions. According to FIG. 2, low hydraulic pressure is present in the control line 29 so that the control valve 28 is switched into the return position 31. In this return position 31, the hammer action chamber 49 is connected via the hammer action line 51 with the low-pressure part 51. The force component resulting from the high hydraulic pressure in the return chamber 48 and acting onto the piston surface area 13 is greater than the force component which results from the hydraulic pressure present in the hammer action chamber 49 and acting on the piston surface area 12. As a result, starting from the position of the push rod 8 according to FIG. 2, movement of the push rod 8 in the return direction 11 (FIG. 1) begins.

In FIG. 3 a detail of the arrangement according to FIG. 2 is illustrated wherein the push rod 8 is illustrated at a later point in time during its movement in the return direction 11. The low-pressure opening 37 in this state is covered by the control piston 35 while the high-pressure opening 36 begins to open. The control valve 29 is still in the return position 31, while, as a result of the beginning opening of the high-pressure opening 36, the high hydraulic pressure of the return chamber 48 begins to build in the control line 29.

According to FIG. 4, the high-pressure opening 36 is now completely released by the control piston 35 so that in the control line 29 the high hydraulic pressure of the return chamber 48 is now present. As a result, the control valve 28 is switched into its hammer action position 30 in which the hammer action chamber 49 is connected via the hammer action line 51 with the high-pressure part 16. As a result of the inertia force of the push rod 8, it continues to perform a movement in the return direction 11 which is braked in a controlled fashion by the high pressure in the hammer action chamber 49. As a result of the inertia force of the push rod 8, hydraulic oil is displaced in the direction of arrow 53 from the hammer action chamber 49 via the hammer action line 51 against the pressure that is present.

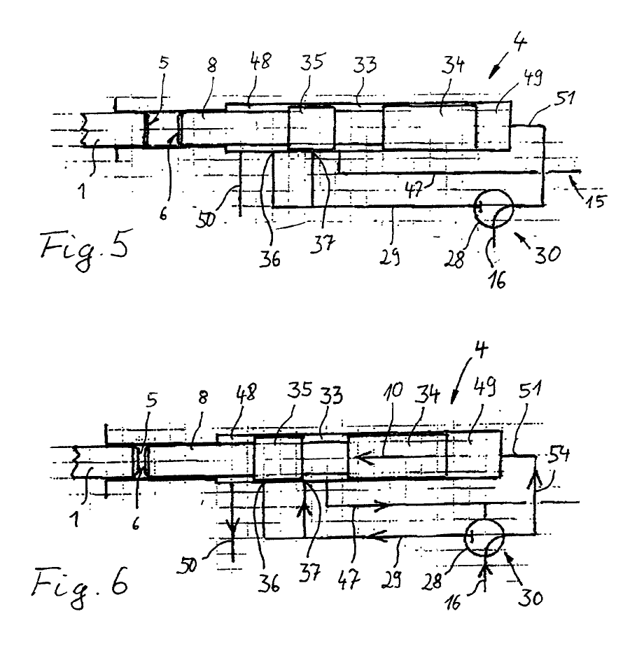

FIG. 5 shows the push rod 8 in the braked rest position at its point of reversal facing away from the tool spindle 1. The control valve 28 is still in the hammer action position 30 so that in the hammer action chamber 49 a high hydraulic pressure is present. However, no volume flow of hydraulic oil through the hammer action line 51 takes place. In this state, the hydraulic pump 17 conveys according to FIG. 1 a volume flow into the high-pressure storage chamber 23. As a result of the identical high hydraulic pressure in the return chamber 48 and in the hammer action chamber 49 in connection with the differently sized piston surface areas 12, 13, a very fast, high energy movement of the push rod 8 in the hammer action direction 10, described in more detail in connection with FIG. 6, takes place.

According to FIG. 6, the push rod 8 is accelerated with high speed in the hammer action direction 10 and is shown shortly before the impact of its contact surface 6 on the contact surface 5 of the tool spindle 1. In the illustrated position, the high-pressure opening 36 is covered by the control piston 35. High pressure is still present in the control line 29. The control valve 28 is still in the hammer action position 30. The low-pressure opening 37 begins to open by movement of the control piston 35 so that the pressure in the control line 29 can be relieved via the control chamber 33 and the low-pressure line 47. As a result of this, the control valve 28 shortly thereafter is switched into the return position 31 illustrated in FIG. 2. Approximately at the same time, the two contact surfaces 5, 6 will then impact on one another so that, because of the fast movement of the push rod 8 in the hammer action direction 10, the resulting impact energy is transmitted onto the tool spindle 1. Subsequent thereto, the movement steps of the push rod 8, which have been illustrated chronologically in FIGS. 2 to 6, will be carried out, as a result of which an oscillating movement of the push rod 8 as well as of the tool spindle 1 in the direction of the axis of rotation 2 is generated. The hammer mechanism 4 can be configured to be switchable, for example, in that the control valve 28 is secured in the position illustrated in FIG. 6. In the hammer action line 51 a permanent high-pressure remains which continuously forces the push rod 8 with its contact surface 6 against the contact surface 5 of the tool spindle. When releasing the control valve 28, the hammer action will again start. A further possibility of switching off the hammer mechanism 4 is provided when locking the control valve 28 in the position illustrated in FIG. 3.

While specific embodiments of the invention have been shown and described in detail to illustrate the inventive principles, it will be understood that the invention may be embodied otherwise without departing from such principles.

What is claimed is:

1. A hand-held hammer drill comprising:
a housing (43);
an electric drive motor (3) arranged in said housing (43);
a tool spindle (1) arranged in said housing (43) and configured to receive a tool;
said tool spindle (1) configured to be driven in rotation by said electric drive motor (3);
said tool spindle (1) having a longitudinal axis and being oscillatingly moveable (10, 11) in a direction of said longitudinal axis (1);
a hammer mechanism (4) configured to move said tool spindle (1) oscillatingly in said direction of said longitudinal axis (1);
a hydraulic drive arranged in said housing (43) and configured to drive said hammer mechanism (4);
said hydraulic drive comprising a hydraulic pump (17) configured to produce a hydraulic pressure for driving said hammer mechanism (4).

2. The hammer drill according to claim 1, wherein said tool spindle (1) and said hammer mechanism (4) are configured as separate parts, wherein said tool spindle (1) has a first contact surface (5) and said hammer mechanism (4) has a second contact surface (6), wherein said first and second contact surfaces (5, 6) contact one another in order to provide hammer action.

3. The hammer drill according to claim 1, wherein said hammer mechanism (4) comprises a cylinder (7) and a push rod (8) with a piston (9), wherein said push rod (8) with said piston (9) is slidingly arranged in said cylinder (7).

4. The hammer drill according to claim 3, wherein said piston (8) has a first end (12) and a second end (13), wherein said hammer mechanism (4) is configured to supply said first end (12) with hydraulic pressure so as to move said piston (8) in a hammer action direction (10) and to supply said second end (13) so as to move said piston (8) in a return direction (11) opposite to said hammer action direction (10).

5. The hammer drill according to claim 4, wherein said second end has an effective piston surface area (13) that is smaller than an effective piston surface area (12) of said first end.

6. The hammer drill according to claim 6, wherein said second end (13) is continuously loaded with a high hydraulic pressure and wherein said first end (12) is loaded oscillatingly with a high hydraulic pressure and a low hydraulic pressure.

7. The hammer drill according to claim 4, wherein said hydraulic drive comprises a hydraulic circuit (14) with a low pressure part (15) and a high pressure part (16), wherein said hydraulic pump (17) is arranged between said low pressure part (15) and said high pressure part (16), wherein said hydraulic pump (17) loads said high pressure part (16) with a hydraulic operating pressure.

8. The hammer drill according to claim 7, wherein said hydraulic pump (17) is a gear pump (18).

9. The hammer drill according to claim 7, wherein said electric drive motor (3) is connected to said hydraulic pump (17) and drives said hydraulic pump (17).

10. The hammer drill according to claim 7, wherein said low pressure part (15) comprises a low pressure storage chamber (19).

11. The hammer drill according to claim 10, wherein said low pressure storage chamber (19) comprises a diaphragm (20) and wherein said diaphragm (20) divides said low pressure storage chamber (19) into a hydraulic chamber (21) and a compensation chamber (22).

12. The hammer drill according to claim 7, wherein said high pressure part (16) comprises a high pressure storage chamber (23).

13. The hammer drill according to claim 12, wherein said high pressure storage chamber (23) comprises a diaphragm (24) and wherein said diaphragm (24) divides said high pressure storage chamber (23) into a hydraulic chamber (25) and a compensation chamber (27).

14. The hammer drill according to claim 13, wherein said compensation chamber (27) is filled with nitrogen.

15. The hammer drill according to claim 7, wherein said hammer mechanism (4) comprises a hydraulically actuated control valve (28) and a control line (29) connected to said control valve (28), wherein said control valve (28) is configured to load said hammer mechanism (4) with hydraulic pressure, wherein, based on a pressure present in said control line (29), said control valve (28) alternatingly switches between a hammer action position (3) and a return position (31).

16. The hammer drill according to claim 15, wherein said piston (9) comprises a peripheral recess (32) forming together with said cylinder (7) an annular control chamber (33), wherein said control chamber (33) is connected to said low pressure part (15), wherein said peripheral recess (32) divides said piston (9) into a hammer piston (34) and a control piston (35), wherein said cylinder (7) has a high pressure opening (36) and a low pressure opening (37) spaced apart from one another in an axial direction of said cylinder (7), wherein said high and low pressure openings (36, 37) are connected to said control line (29), respectively, and wherein said control piston (35) is configured to alternatingly cover one of said high and low pressure openings (36, 37).

17. The hammer drill according to claim 16, wherein said control piston (35) and said high and low pressure openings (36, 37) are aligned with one another such that a movement of said push rod (8) in said return direction (11) is hydraulically braked.

18. The hammer drill according to claim 1, comprising an anti-vibration device (38) effective in said hammer action direction (10).

19. The hammer drill according to claim 18, wherein said anti-vibration device (38) has an adjusted vibration damper (39) comprising a counter oscillator (41) and a spring element (40), wherein said counter oscillator (41) is connected to said spring element (40) and said spring element (43) is connected to said housing (43).

20. The hammer drill according to claim 1, comprising a rotary drive (44, 45, 46) connected to said electric drive motor (3) and configured to rotate said tool spindle (1), wherein said rotary drive (44, 45, 46) and said hydraulic drive are configured to be switched on and off independently from one another.
